(19) United States
(12) Patent Application Publication
(10) Pub. No.: US 2012/0316933 A1
(43) Pub. Date: Dec. 13, 2012

(54) METHOD FOR PROMOTING BEHAVIOR CHANGE THROUGH SOCIAL REWARD MEDIATION

(75) Inventors: Alex Paul Pentland, Lexington, MA (US); Iyad Rahwan, Dubai (AE)

(73) Assignee: Massachusetts Institute of Technology, Cambridge, MA (US)

(21) Appl. No.: 13/492,305

(22) Filed: Jun. 8, 2012

Related U.S. Application Data
(60) Provisional application No. 61/495,170, filed on Jun. 9, 2011.

(51) Int. Cl. G06Q 30/02

(52) U.S. Cl. 705/14.1

(57) ABSTRACT

Disclosed herein are methods and systems for influencing behavior in social settings. The method/system gathers information about the behavior of socially connected entities/individuals, for example, and computes monetary rewards, for example, to distribute to these individuals, thus giving them incentive to adopt a particular behavior. Examples of applications include health insurance, car insurance, power production, weight-loss programs, and public utilities. These methods and systems can be twice as efficient in terms of effect per cost as compared to previous approaches. These methods and systems can improve overall quality of service among computer networks.

### RELATED APPLICATION(S)

This application claims the benefit of U.S. Provisional Application No. 61/495,170, filed on Jun. 9, 2011.

The entire teachings of the above application are incorporated herein by reference.

### BACKGROUND OF THE INVENTION

In a variety of domains, organizations and policy makers look for reliable and effective ways to promote specific positive behaviors. For example, health organizations often attempt to promote an active lifestyle in order to reduce the risk of heart disease, obesity, or diabetes. In the domain of energy, corporations are often interested in reducing their total energy bills by encouraging individuals to conserve consumption, while municipalities and utility companies may want to incentivize people to reduce peak energy demand (e.g., by shifting their consumption load around the day). In some domains, behavior change may be achieved through pricing and market mechanisms. For example, in the energy domain, utilities may use variable electricity pricing to encourage people to reduce consumption in peak hours. In other domains, such as promotion of healthy behavior, market mechanisms may be difficult (or even impossible) to apply. Here, policy makers rely on strategies based on research in marketing, behavioral psychology, and behavioral economics to nudge people towards particular behaviors. These techniques vary from changing the way options are framed to promoting positive norms through advertising or information aggregation.

### SUMMARY

Against this background, methods and system presented herein efficiently induce behavior change in social groups based on an ability to sense individual behavior. Presented herein are novel methods and systems for inducing behavior change in individuals via incentives mediated through their social network. One method, for example, is applicable to domains ranging from promoting a healthy lifestyle to adopting sustainable or environmentally-friendly behavior. Both experiment and theory show these new methods and systems can be twice as efficient in terms of effect per cost as compared to previous methods.

According to one example embodiment, a system for incentivizing activities includes a plurality of entities having preexisting relationships with a given entity. The system further includes a monitoring device, feedback mechanism, and reward mechanism. The monitoring device is associated with the given entity and tracks activities of the given entity. The feedback mechanism allows the plurality of entities to provide feedback to the given entity regarding the activities of the given entity. The reward mechanism determines rewards for the plurality of entities based on the tracked activities of the given entity and provides the rewards to the plurality of entities.

According to another example embodiment, a method for achieving a community goal includes establishing an egonetwork for an individual in a community and assigning incentives across the individual's egonetwork. An individual's egonetwork as used herein is defined as a social structure or network of individuals and connections therebetween. It should be understood that other definitions of egonetwork are contemplated herein, and such other definitions may apply based on an environment or application for which embodiments of the present invention are employed. The method also includes measuring the individual's contributions toward the community goal, calculating values for the incentives based on contributions by the individual toward the community goal, and providing the incentives to members of the individual's egonetwork.

According to another example embodiment, a method for achieving a community goal includes establishing positive feedback incentive relationships among individuals with preexisting relationships within a community and notifying the individuals of incentives for working toward the community goal. The individuals are then rewarded with the incentives based on positive feedback relationships with a given individual for behaviors of the given individual toward the community goal.

According to another example embodiment, a method for incentivizing activities includes determining for a given individual a number of other individuals with whom to take part in an incentive mechanism and notifying individuals of incentive mechanism goals and rewards. The method involves monitoring activities of the given individual, determining rewards for the other individuals based on the activities of the given individual, and providing the rewards to the other individuals.

According to another example embodiment, a system for discouraging activities includes a plurality of entities having preexisting relationships with a given entity. The system also includes a monitoring device, feedback mechanism, and penalty mechanism. The monitoring device is associated with the given entity and tracks activities of the given entity. The feedback mechanism allows the plurality of entities to provide feedback to the given entity regarding the activities of the given entity. The penalty mechanism determines penalties for the plurality of entities based on the tracked activities of the given entity and confers the penalties on the plurality of entities.

According to another example embodiment, a method for incentivizing cooperation among a plurality of networks in communication with a given network, where the plurality of networks and given network, obligated to forward network traffic to adjacent networks, includes establishing a universal quality of service charge for each unit of network traffic handled by the networks. The method then determines whether the given network attempts to relieve network traffic congestion to improve overall quality of service among the networks, and allocates a portion of the received charges to networks that attempt to relieve network traffic congestion among the networks.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram illustrating a peer group that may qualify for being incentivized to promote behavior change through social reward mediation.

FIG. 1B is a set of diagrams further illustrating peer groups that may qualify for being incentivized to promote behavior change through social reward mediation.

FIG. 1C is a diagram illustrating a plurality of networks that may qualify for being incentivized to promote change to traffic forwarding through social reward mediation.

FIG. 2 illustrates a method for incentivizing cooperation among a plurality of networks in communication with a given network.

FIG. 3 illustrates an example method for inducing behavior change using a social monetary incentive.

FIG. 4 is an example graphical report showing the rewards earned by an individual as a result of the activities of his buddies.

FIG. 5 shows the total reward generated by the activity of an individual and earned by his two buddies.

FIG. 6 illustrates an embodiment of a method for achieving a community goal.

FIG. 7 illustrates another embodiment for a method for achieving a community goal.

FIG. 8 illustrates an embodiment of a method for incentivizing activities.

FIG. 9 illustrates an example computing environment in accordance with embodiments described herein.

FIG. 10 illustrates flow diagrams for a server and client.

FIG. 11 illustrates a block diagram of a computer operable to execute the various embodiments described herein.

### DETAILED DESCRIPTION

A description of example embodiments of the invention follows. The novel system and methods herein promote behavior change through social mediation. Techniques discussed herein may influence how a group of people work together. By applying peer pressure, people may be influenced to behave better. As discussed herein, the techniques may be applied to networks in communication, and may promote a changing in forwarding of traffic to promote relief of traffic congestion.

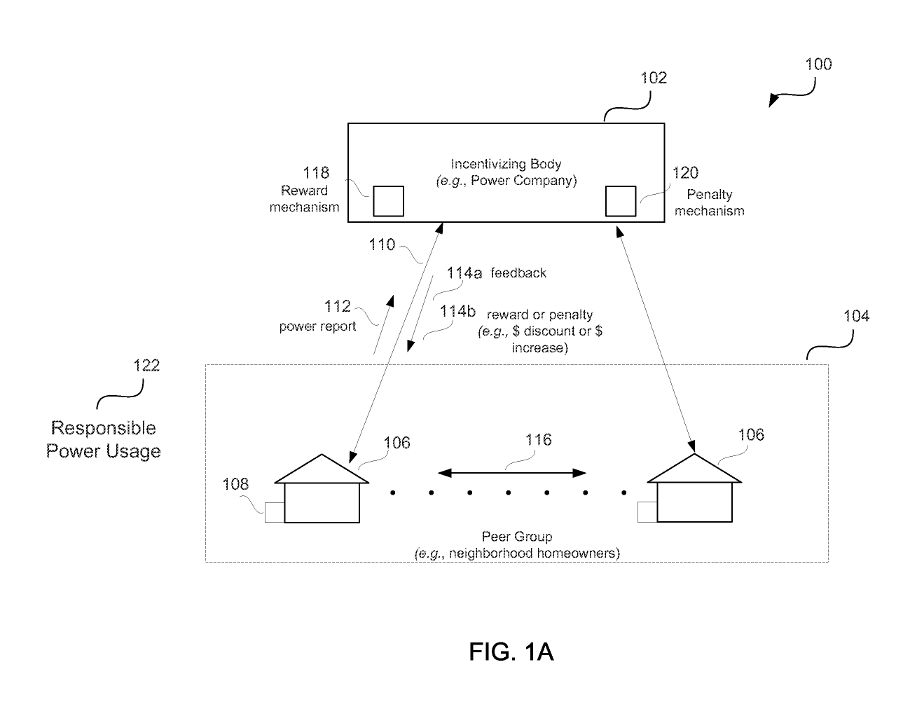

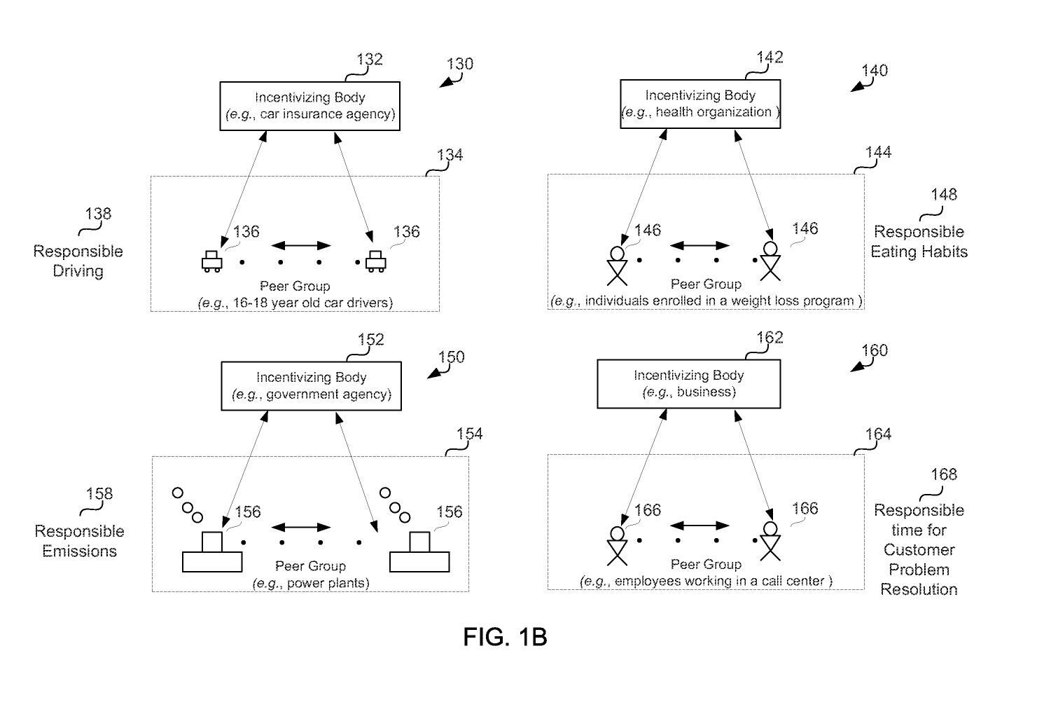

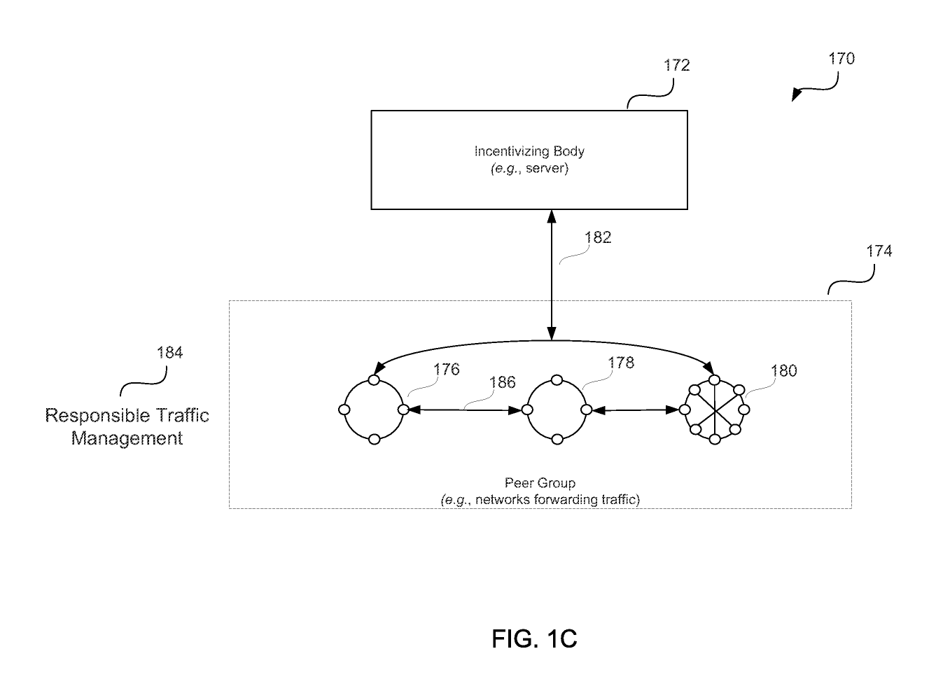

FIG. 1A is a diagram 100 illustrating an example peer group 104 that may qualify for being incentivized to promote behavior change through social reward mediation. The peer group 104 may include a plurality of neighborhood homeowners 106, sometimes referred to herein as “entities.” The entities 106, in the embodiment of FIG. 1A, may have preexisting relationships with a regulating, or incentivizing, body 102. It should be understood that the entities 106 may have contact 116 with each other and with the regulating, or incentivizing body, 102.

In the embodiment of FIG. 1A, the incentivizing body 102 may be a power company supplying energy to the neighborhood homeowners 106. The neighborhood homeowners 106 may have a monitoring device 108, such as an energy meter or other suitable monitoring device, associated with their residence. The monitoring device 108 may be a software program embodied in a power meter or a computing device, such as a handheld computing device (e.g., cell phone, personal data assistant), or any other suitable computing device. The monitoring device 108 may include a sensing device for sensing energy usage, or the monitoring device 108 may communicate with a sensing device.

The monitoring device 108 may track the energy usage of a neighborhood homeowner 106. Power reports 112 may be sent from the monitoring devices 108 of each of the neighborhood homeowners 106 to the power company 102, including information regarding tracked energy usage of each neighborhood homeowner 106. Processing and other functions may be used to track and determine energy usage of the neighborhood homeowners 106, which generate or transmit power reports from the neighborhood homeowners 106. The processing or other functions may be executed by a database operating on a computing device (not shown). The computing device may be coupled to a computer network in which various processes are distributed about nodes on the network.

The power reports 112 may be sent in any suitable manner, for example by utilizing a local area network (LAN), wireless network, or any other suitable network providing infrastructure for communication between the incentivizing body 102 and the computing devices of the neighborhood homeowners 106. The neighborhood homeowners 106 may receive feedback 114a, such as power reports, summarizing the energy usage of each of the neighborhood homeowners in the peer group 104. The feedback 114a may include feedback from the plurality of homeowners 106 regarding the energy usage.

The power company 102 may have a reward mechanism 118. In the embodiment of FIG. 1A, the power company 102 may incentivize the neighborhood homeowners 106 in the peer group 104 by offering a reward 114b, such as a monetary discount applied to the cost of energy. The monetary discount may be based on the energy consumption activities of the neighborhood homeowners 106 in the peer group 104.

According to an alternative embodiment of FIG. 1A, the power company 102 may have a penalty mechanism 120. The power company 102 may discourage the neighborhood homeowners 106 in the peer group 104 from an energy consuming activity, such as consuming energy during peak hours. In the alternative embodiment of FIG. 1A, the power company 102 may penalize the neighborhood homeowners 106 in the peer group 104 by applying a penalty 114b, such as increasing a cost of energy based on increased power consumption activities during peak hours. The neighborhood homeowners 106 may have their power consumption activities summarized in power reports 112, such that the power company 102 may determine a reward or penalty 114b based on the alignment of the tracked activities with a common goal, such as responsible power usage 122. The neighborhood homeowners 106 may receive the feedback 114a in the form of an email exchange, web-posting, or any other suitable notification mechanism.

Collectively, the peer group 104 of neighborhood homeowners 106 may all want to employ responsible power usage activities, and the neighborhood homeowners 106 may enroll together as a peer group 104 with the power company 102. The neighborhood homeowners 106 may receive power reports in the feedback 114a for all of the neighborhood homeowners 106 in the peer group 104. Responsible power usage behavior may be promoted through social mediation as the neighborhood homeowners 106 may apply peer pressure to each other to encourage more responsible behavior.

FIG. 1B is a set of diagrams illustrating other example peer groups that may qualify for being incentivized to promote behavior change through social reward mediation. According to one embodiment, FIG. 1B diagram 130 illustrates an environment in which a car insurance agency 132 may promote responsible driving of a peer group 134 of car drivers 136 in a 16-18 year old age group. For example, the car agency 132 may apply insurance rate discounts or increases based on feedback regarding tracked speed history of the car drivers 136. A monitoring device, such as any suitable computing device, including a mobile device (not shown) having thereon an application configured to track movement or speed, may be associated with the car driver's car and may track activities such as speed by sensing the car driver's speed activity sensed by a device, such as a speedometer. The car insurance agency 102 may determine a reward or penalty based on the alignment of the tracked activities with a common goal, such as responsible driving 138. Processing and other functions used to determine a reward or penalty may be executed by a database operating on a computing device, where the computing device may be coupled to a computer network over which the computing device may communicate with the monitoring device.

According to another embodiment of FIG. 1B, diagram 140 illustrates an environment in which a health organization may promote a goal of responsible eating habits 148 of a peer group 144 including individuals 146 enrolled in a weight loss program. A monitoring device (not shown) may sense weight of the individuals 146 over time and provide as feedback the tracked weight of the individuals 146 to the health organization.

According to yet another embodiment of FIG. 1B, diagram 150 illustrates an environment in which a government agency may promote a goal of responsible emissions 158 of a peer group 154 including power plants 156. A monitoring device (not shown) may sense a level of CO₂ emissions of the power plants 156 and report the levels to the government agency.

Further, according to another embodiment of FIG. 1B, diagram 160 illustrates an environment in which a business may promote a goal of responsible time for customer problem resolution 168 of a peer group 164 including employees 166 working in a call center. A monitoring device may track the number of customer calls received by the employees 166 and determine an amount of time to resolve the issue reported by the customer on each call.

FIG. 1C is a diagram illustrating a plurality of computer or communications networks that may qualify for being incentivized to promote change to traffic forwarding through social reward mediation. For example, an Internet Service Provider (ISP) may employ a server 172 that may be used to incentivize cooperation among a plurality of networks 176, 178, and 180, in a peer group 174. ISPs may pay for upstream Internet access. To promote an improvement of overall quality of service among the networks, an ISP may allocate a portion of the received charges to networks that have been determined to attempt to relieve network traffic congestion among the networks.

The server 172 may include a variety of suitable communications modules and may exchange data traffic and other control management and status messages that may be communicated over a network path 182 with the networks in the peer group 174. The networks 176, 178, and 180 may be ring, mesh, or any other type of network that may be suitable for forwarding traffic. Traffic may be forwarded using any appropriate medium, including, but not limited to, wireless, wireline, optical fiber cable, RF, etc., or any suitable combination of the foregoing.

The networks 176, 178, and 180 may forward network traffic to adjacent networks, such as data packets being forwarded between adjacent networks 176 and 178 along a network path 186. A universal quality of service charge may be established by the server 172 for each unit of network traffic handled by the networks 176, 178, and 180. The server 172 may determine if the networks 176, 178, and 180 attempt to relieve network traffic congestion. To promote an improvement of overall quality of service among the networks 176, 178, and 180, the server 172 may allocate a portion of the received charges to networks that have been determined to attempt to relieve network traffic congestion among the networks.

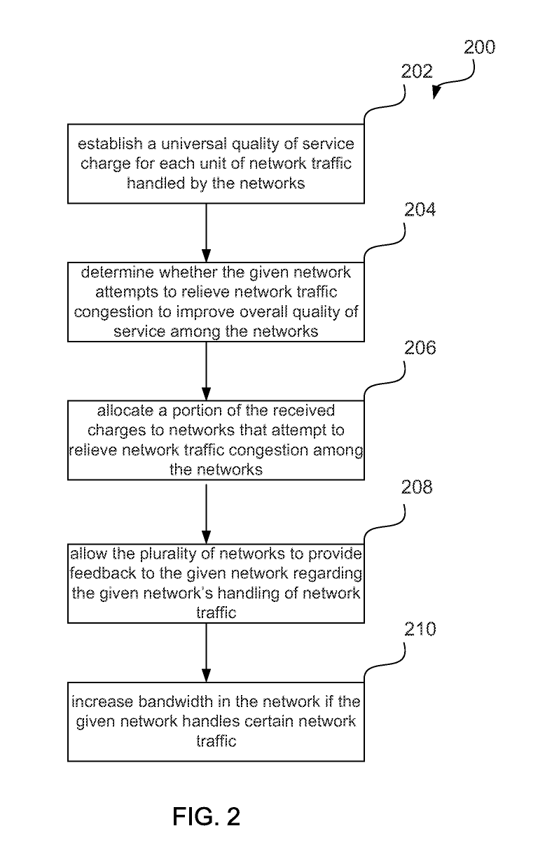

FIG. 2 illustrates a method 200 for incentivizing cooperation among a plurality of networks in communication with a given network. The plurality of networks and the given network may be obligated to forward network traffic to adjacent networks.

The method 200 may establish a universal quality of service charge for each unit of network traffic handled by the networks (202). The method 200 may then determine whether the given network attempts to relieve network traffic congestion to improve overall quality of service among the networks (204). For example, the method 200 may determine whether the given network buffers network traffic in an attempt to relieve network traffic congestion. The method 200 may determine whether the given network selectively forwards network traffic to less-congested networks. The method may allocate a portion of the received charges to networks that attempt to relieve network traffic congestion among the networks (206). The method 200 may allow the plurality of networks to provide feedback to the given network regarding the given network's handling of network traffic (208). The method may increase bandwidth in the network if the given network handles certain network traffic, which may be a detriment to that network but an overall benefit to the peer group of networks (212). However, as a result, the network receives a benefit, such as an allocation of a portion of charges collected by the server overseeing the activities of the networks or, as another example, a portion of tax revenues collected by a governmental body for communications and networking administration.

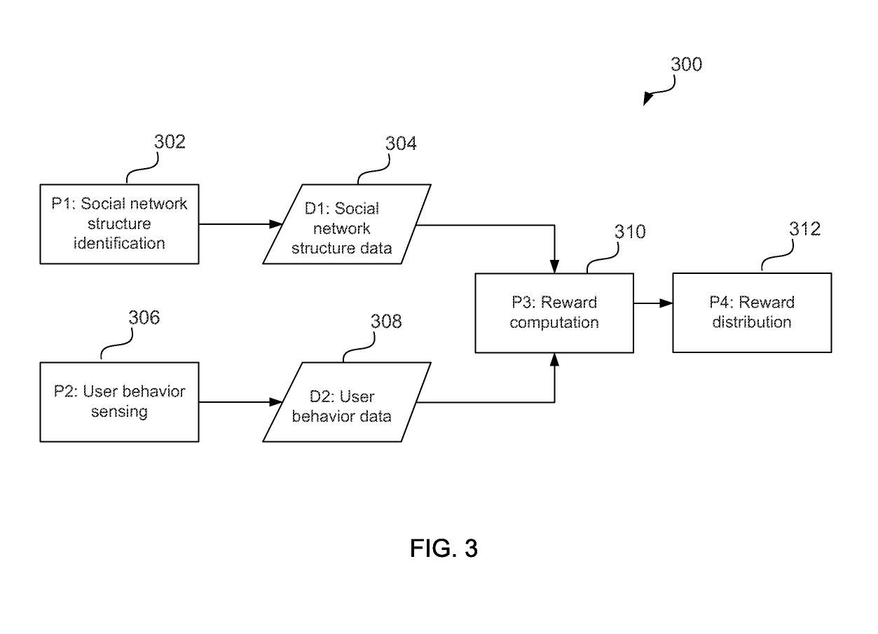

FIG. 3 illustrates an example method 300 for inducing behavior change using a social monetary incentive. The method 300 is described schematically in FIG. 3, and each part of the diagram is detailed below.

P1—Social network structure identification (302). Social network structure data is either assigned or collected. The specific manner in which this is done depends on the domain of application. For example, it may be possible to use the structure of an online social network application to collect this information. Alternatively, an existing organizational hierarchy may be taken from a company's organization chart. Yet another way to sense the social network structure may involve the use of mobile phone sensing technologies. The result of this process is a representation of the social structure data (D1) shown at 304. For each person, this data 304 identifies (or assigns) a number of peers (or “buddies”).

P2—Individual Behavior Sensing (306). Information (D2) about the performance of an individual with respect to the behavior in question is collected as shown by 308. The following are some examples:

Health: In the health domain, an accelerometer may be used to measure the activity or physical exercise level of an individual.

Business: In the business domain, a performance measure may be used in a business setting (e.g., number of issues resolved by an individual working in a call center).

Energy: Yet another example is collecting quantitative information about an individual's energy consumption or recycling.

P3—Reward Computation (310). A reward (monetary or symbolic) may be computed as follows. Suppose, according to D1 (304), an individual i has a set of buddies B={b1, . . . ,bn} in the extracted social structure. It may be assumed that there is a performance measure such that m(i) denotes the level of performance of i in terms of the behavior in question. In one example method, the reward r(bj) awarded to each buddy is proportional only to the behavior of i.

As a specific example, suppose the performance measure ranges from 1 to 10. Suppose also that the reward to each individual is a monetary value between $1 to $10. Then suppose the performance measure of person i is m(i)=4, then each buddy b1, . . . ,bn may be paid a reward r(bj)=$4. Had the individual i achieved a higher performance measure of m(i)=8, the system may have computed a reward r(bj)=$8 for each buddy.

P4—Reward Distribution (312). Rewards may be distributed to all individuals. Each individual may also receive a report of the rewards they collected based on the behavior of each of their buddies.

The methods and systems described herein may be demonstrated in the context of students living in a dorm or tenants of an assisted living home, where the objective is to encourage people to adopt a more active lifestyle.

For example, P1—Social Network Identification (302), the structure of a social graph may be created by assigning two “buddies” to each individual. These buddies were members of the same dorm; hence, there is a chance of ongoing interaction.

At P2—Individual Behavior Sensing (306), in this example, the target behavior is physical activity. This may be measured using accelerometers in mobile phones provided to participants. Accelerometer readings can be taken, for example, for 15 seconds every 2 minutes. Record of a total score that reflect the individual's activity may be tracked. An individual may receive 1 point per second if the variance in his accelerometer data is above a certain threshold, up to 15 points per reading.

At step P3—Reward Computation (310), in this example, the total reward generated by a person is computed based on the sum of person's score, specifically on a percentage improvement in activity the person makes over the average (across all users) over a 3-day moving window. Rewards may be in 50 cent increments up to $5. This total reward may be allocated to the person's “buddies” equally.

At P4—Reward Distribution (312), in this example, the rewards computed above may be distributed to the person's buddies. Hence, each person may be given a graphical report showing the rewards received due to the activities of each of the two buddies.

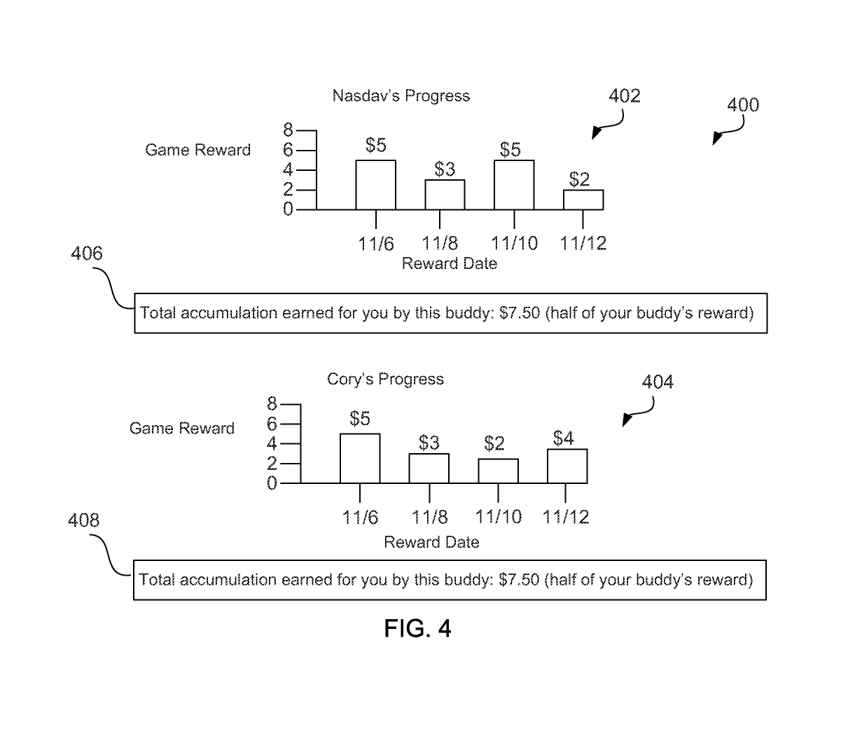

FIG. 4 is an example graphical report 400 showing the rewards earned by “Wei” (406, 408) as a result of the activities of his buddies “Nasdav” and “Cory.” In the example of FIG. 4, graph 402 shows a report of “Nasdav”'s game reward earnings on dates of a month. “Wei” may receive a report of “Nasdav”'s game reward progress as a report sent to “Wei”'s cell phone. Wei may view “Nasdav”'s game reward progress (402) as well as “Wei”'s total reward accumulation earned for “Wei” by his buddy “Nasdav” (406). In the example of FIG. 4, graph 404 shows a report of “Cory”'s game reward earnings on dates of a month. “Wei” may receive a report of “Cory”'s game reward progress as a report sent to “Wei”'s cell phone. “Wei” may view “Cory”'s game reward progress (404) as well as “Wei”'s total reward accumulation earned for “Wei” by his buddy “Nasdav” (408).

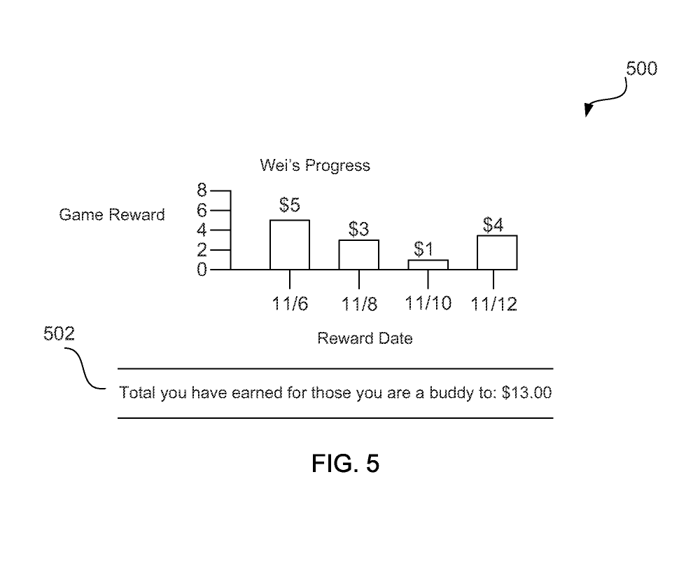

FIG. 5 illustrates that each person may be shown the total reward contributed (through his/her physical activity) towards those same buddies as shown in FIG. 4. FIG. 5 is a graph 500 that shows all of the “Wei”'s game rewards for the past 12 days. “Wei” may receive a report of “Wei”'s game reward progress as a report sent to “Wei”'s cell phone. In the example of FIG. 5, the graph 500 shows the total reward generated by the activity of “Wei” and earned by his two buddies (502).

While one past approach typically used to incentivize behavior change is through direct monetary reward to the individual adopting the behavior, the novel approaches described herein offer an alternative by, instead, rewarding the “buddies” of that individual. One advantage of the disclosed mechanisms lies in an ability to harness peer pressure and peer influence. By rewarding an individual's “buddies,” the buddies have an incentive to encourage the individual to adopt the behavior in question.

The disclosed mechanisms also offer advantages over existing methods that rely solely on norm information mediation. For example, to promote reduction in household energy consumption, an existing approach provides a solution that aggregates consumption data from similar sized households. This promotes a norm about what is an acceptable consumption level. This existing approach also offers individual rewards in the form of a positive message. However, this relies on people's abilities to internalize these norms themselves, and does not leverage ongoing social interactions with their peers. In actual practice, the disclosed incentive mechanisms according to example embodiments of the present invention are about twice as efficient at inducing behavior change as these other incentive methods. That is, it requires about half as much reward cost to obtain the same amount of behavioral change.

In commercial applications, there are several embodiments that can be used to promote different kinds of behaviors in social settings, e.g. schools, dorms, organizations, clubs, residential communities. As a consequence, the range of potential commercial applications includes almost every consumer-facing business. For example, as describe herein, the disclosed methods and systems may be used with weight-loss programs, car insurance, public utilities, and computer networks. Many other environments in which peer groups can be formed are also contemplated within example embodiments disclosed herein.

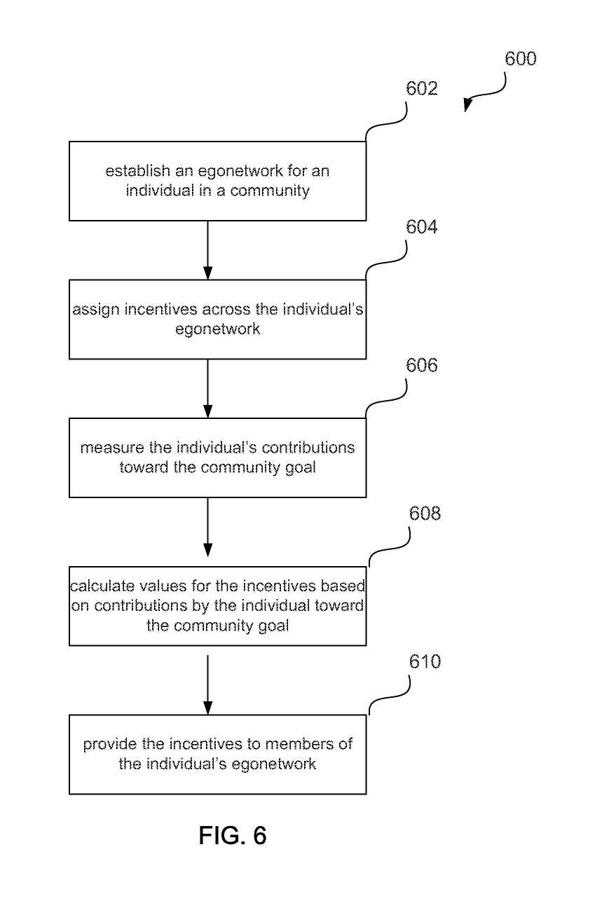

FIG. 6 illustrates an embodiment of a method 600 for achieving a community goal. The method 600 may establish an egonetwork for an individual in a community (602) and incentives across the individual's egonetwork may be assigned (604). The method 600 may further measure the individual's contributions toward the community goal (606), and calculate values for the incentives based on contributions by the individual toward the community goal (608). Then, the method 600 may provide the incentives to the members of the individual's egonetwork (610).

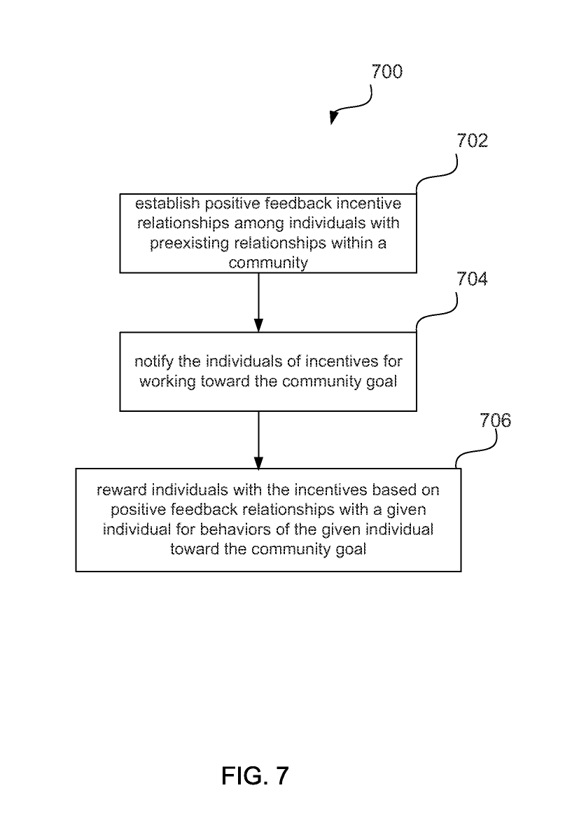

FIG. 7 illustrates another embodiment 700 for a method for achieving a community goal. The method may establish positive feedback incentive relationships among individuals with preexisting relationships within a community (702). The method 700 may notify the individuals of incentives for working toward the community goal (704). The method 700 includes rewarding the individuals with the incentives based on positive feedback relationships with a given individual for behaviors of the given individual toward the community goal (706).

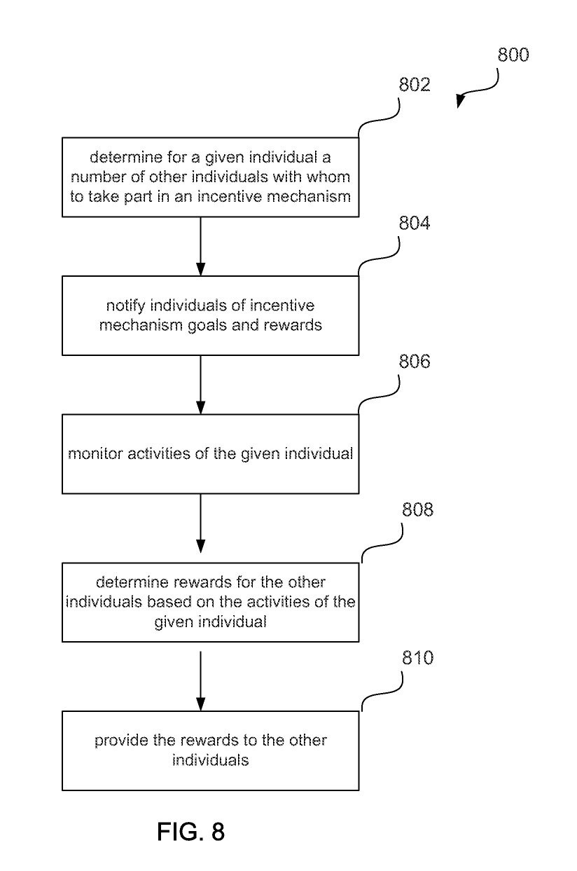

FIG. 8 illustrates an embodiment of a method 800 for incentivizing activities. The method may determine for a given individual a number of other individuals with whom to take part in an incentive mechanism (802). The method may notify individuals of incentive mechanism goals and rewards (804). The method may monitor activities of the given individual (806), and then, the method may determine rewards for the other individuals based on the activities of the given individual (808). The method thereafter provides the rewards to the other individuals (810).

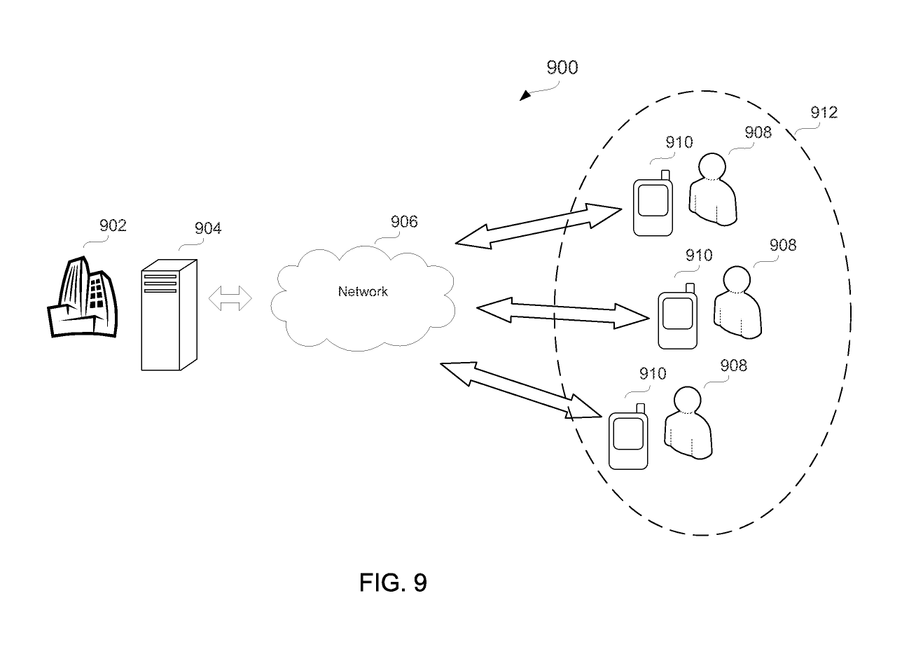

FIG. 9 illustrates an example computing environment in accordance with embodiments described herein. The system 900 includes one or more client(s) 910. The client(s) 910 are shown as computing devices, such as handheld devices, for example. The clients(s) 910 can be hardware and/or software (e.g., threads, processes, etc.). The system 900 includes one or more server(s) 904. The server(s) 904 can also be hardware and/or software (e.g., threads, processes, etc.). The system 900 includes a communication framework 906 (e.g., a global communication network such as the Internet) that can be employed to facilitate communications between the client(s) 910 and the server(s) 904. Communications may be facilitated via a wired (including optical fiber) and/or wireless, or any other suitable technology. The client(s) 910 are operably connected to one or more client data store(s) that can be employed to store information local to the client(s). Similarly, the server(s) 904 are operably connected to one or more server data store(s) that can be employed to store information local to the servers 904, such as discussed above in reference to FIG. 1A, FIG. 1B, and FIG. 1C. An incentivizing body 902 may utilize local or remote server(s) 904 to, for example, incentive activities, while local or remote client(s) 910 may be utilized, for example, to monitor activities of entities 908 in a peer group 912.

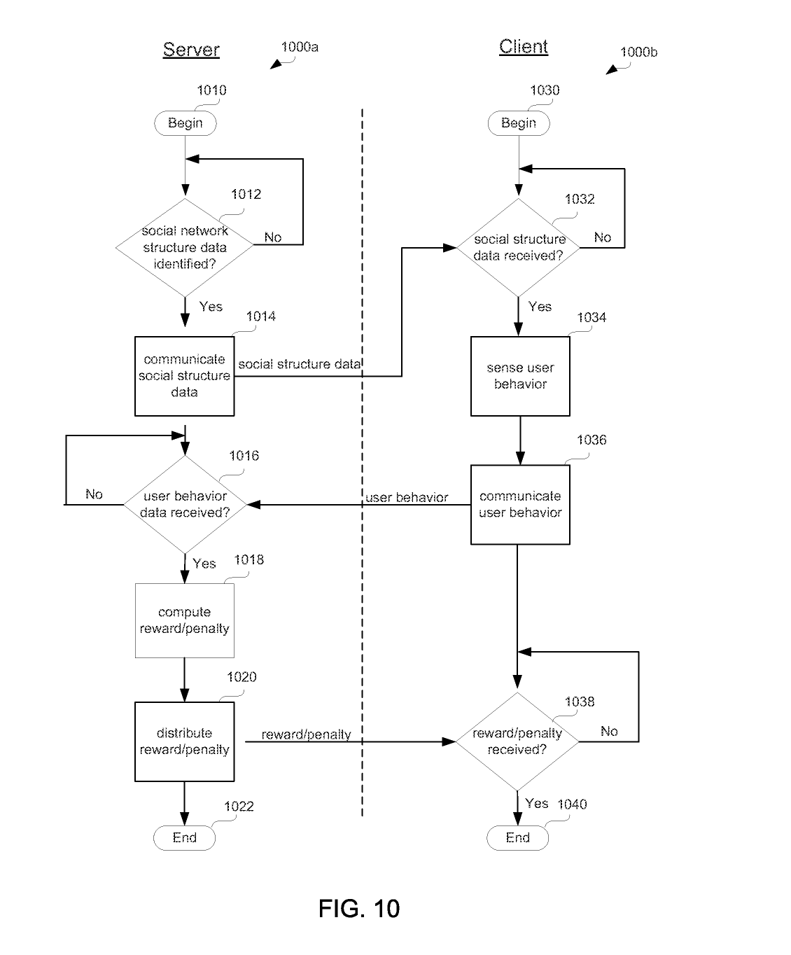

FIG. 10 illustrates flow diagrams 1000a and 1000b, for a server and client, respectively, which illustrate an embodiment of data communication between server(s) and client(s) in accordance with techniques described herein. The server begins (1010) by checking (1012) whether or not social network structure data has been identified. If social network structure data has been identified, the structure data may be communicated to a client(s) (1014). After communicating the structure data to the client(s), the server may wait (1016) to receive user behavior data being monitored by the client(s). If user behavior data is received, then a reward or penalty may be computed (1018). After computing the reward or penalty, the reward or penalty may be communicated to the client(s) (1020) and the flow may end (1022). The client flow diagram 1000b begins (1030) after which the client waits to receive social structure data from the server(s). After receiving social structure data, sensing of user behavior may occur (1034), and then the user behavior data may be communicated (1036) to the server(s). After communicating the user behavior data, the client(s) may wait to receive reward/penalty information (1038). If the reward/penalty information is received then the flow may end as shown (1040).

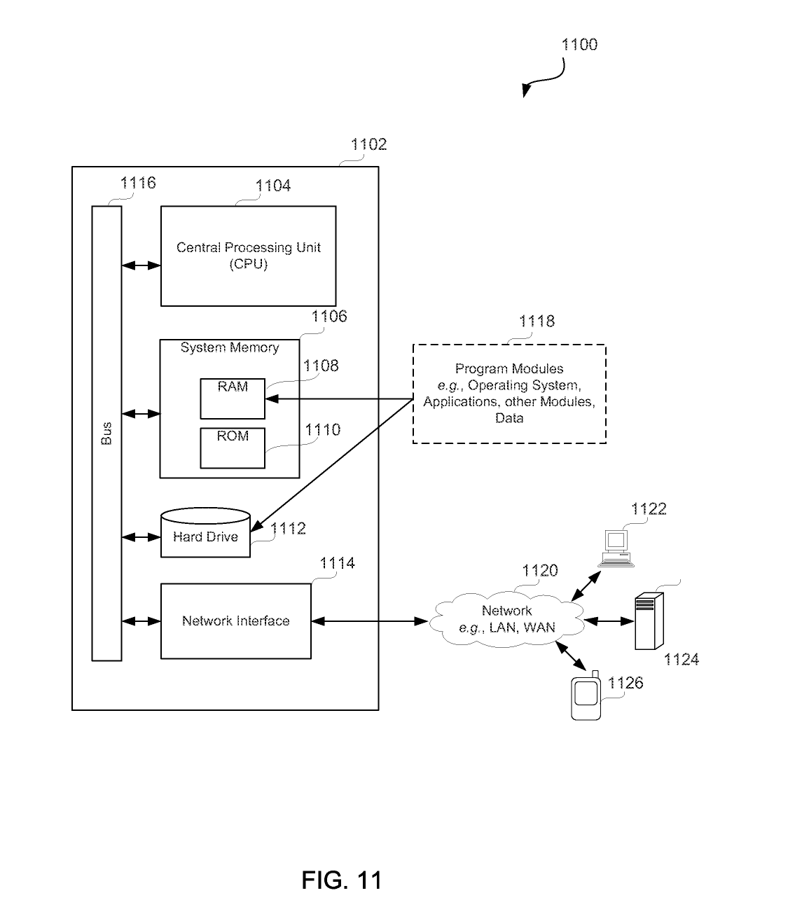

FIG. 11 illustrates a block diagram of a computer 1102 operable to execute the various embodiments described herein. For example, computer 1102 may be employed to implement any of the methods discussed herein. For example, computer 1102 may be employed as, but is not limited to, either the server or client as referenced with respect to FIG. 10. FIG. 11 and the following discussion are intended to provide a brief, general description of a suitable computing environment 1100 in which various aspects described herein may be implemented. While the various embodiments described above may be described in the general context of computer-executable instructions that may run on one or more computers, those skilled in the art will recognize that embodiments described herein may be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods described herein may be practiced with other computer system configurations, including single-processor or multiprocessor computer systems, minicomputers, mainframe computers, as well as personal computers, routers, hand-held computing devices, microprocessor-based or programmable consumer electronics, and the like, each of which may be operatively coupled to one or more associated devices. The illustrated embodiments may also be practiced in distributed computing environments where certain tasks are performed by remote processing devices that are linked through a communications network. In a distributed computing environment, program modules may be located in both local and remote memory storage devices.

With reference again to FIG. 11, there is illustrated an example environment 1100 for implementing various embodiments described herein includes a computer 1102, the computer 1102 including a processing unit 1104, a system memory 1106 and a system bus 1116. The system bus 1116 couples system components including, but not limited to the system memory 1106 to the processing unit 1104. The processing unit 1104 may be any of various commercially available processors. Dual microprocessors and other multi-processor architectures also can be employed as the processing unit 1104.

The system bus 1116 can be any of several types of bus structure including a memory bus or memory controller, a peripheral bus and a local bus using any of a variety of commercially available bus architectures. The system memory 1106 includes read only memory (ROM) 1110 and random access memory (RAM) 1108. A basic input/output system (BIOS), containing the basic routines that help to transfer information between elements within the computer 1102, such as during start-up, is stored in the ROM 1110.

The computer 1102 further includes a hard disk drive 1112, and may also include a magnetic disk drive (e.g., to read from or write to a removable disk), an optical disk drive (e.g., to read from a CD-ROM disk or to read from or write to other optical media). The hard disk drive 1112, and other disk drives such as a magnetic disk drive and optical disk drive, can be connected to the system bus 1116 by any suitable interface. The drives and their associated computer-readable media provide nonvolatile storage of data, data structures, computer-executable instructions, and so forth. For the computer 1102, the drives and media accommodate the storage of broadcast programming in a suitable digital format. Although the description of computer-readable media above refers to a hard disk, a removable magnetic disk and a CD, it should be appreciated by those skilled in the art that other types of media which are readable by a computer, such as zip drives, magnetic cassettes, flash memory cards, digital video disks, cartridges, and the like, may also be used in the example operating environment, and further that any such media may contain computer-executable instructions for performing the methods of the present invention.

A number of program modules 1118 can be stored in the drives and RAM 1108, including an operating system, one or more application programs, other program modules, and program data. It is appreciated that aspects described herein can be implemented with various commercially available operating systems or combinations of operating systems.

The computer 1102 may operate in a networked environment using logical connections to one or more remote computing devices. The remote computing devices may be a personal computer 1122, workstation 1124, handheld device 1126, or other (not shown) device such as a server computer, portable computer, microprocessor-based entertainment appliance, router, a peer device or other common network node, and typically includes many or all of the elements described relative to the computer 1102. The logical connections depicted include a local area network (LAN) and a wide area network (WAN) 1120, but are not limited to those shown. Such networking environments are commonplace in offices, enterprise-wide computer networks, intranets and the Internet.

When used in a LAN networking environment, the computer 1102 is connected to the local network 1120 through a network interface or adapter 1114. The adapter 1114 may facilitate wired or wireless communication to the LAN 1120, which may also include a wireless access point disposed thereon for communicating with the wireless adaptor 1114. When used in a WAN networking environment, the computer 1102 may include a modem, or may be connected to a communications server on the LAN, or may have other means for establishing communications over the WAN 1120, such as the Internet. It will be appreciated that the network connections shown are examples and other means of establishing a communications link between the computing devices may be used.

As will be appreciated by one skilled in the art, aspects described herein may be embodied as a system, method or computer program product. Accordingly, aspects of described herein may take the form of an entirely hardware embodiment, an entirely software embodiment (including firmware, resident software, micro-code, etc.) or an embodiment combining software and hardware aspects that may all generally be referred to herein as a “module” or “system.”

Embodiments of the present invention may be implemented in a variety of computer architectures. The figures are for purposes of illustration and not limitation of any embodiments of the present invention.

Aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. Embodiments may be implemented in hardware, firmware, software, or any combination thereof.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transitory machine-readable medium may include read only memory (ROM); random access memory (RAM); magnetic disk storage media; optical storage media; flash memory devices; and others. Further, firmware, software, routines, or instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the block diagrams may include more or fewer elements, be arranged differently, or be represented differently. It should be understood that implementation may dictate the block and flow diagrams and the number of block and flow diagrams illustrating the execution of embodiments of the invention.

While this invention has been particularly shown and described with references to example embodiments thereof, it will be understood by those skilled in the art that various changes in form and details may be made therein without departing from the scope of the invention encompassed by the appended claims.

What is claimed is:

1. A system for incentivizing activities, the system comprising:
a plurality of entities having preexisting relationships with a given entity;
a monitoring device associated with the given entity and configured to track activities of the given entity;
a feedback mechanism configured to allow the plurality of entities to provide feedback to the given entity regarding the activities of the given entity; and
a reward mechanism configured to determine rewards for the plurality of entities based on the tracked activities of the given entity and configured to provide the rewards to the plurality of entities.

2. A system as in claim 1 wherein the monitoring device is a motion sensor of a personal communications device.

3. A system as in claim 1 wherein the monitoring device is a software program embodied in a computing device, the software program configured to track activities of the given entity with respect to the computing device.

4. A system as in claim 1 wherein the monitoring device is an energy meter associated with a residence.

5. A system as in claim 1 wherein the reward mechanism is further configured to determine a higher reward for the plurality of individuals if the tracked activities of the given entity are in line with a common goal.

6. A system as in claim 1 wherein the plurality of entities are any of individuals involved in a weight-loss program, buyers of car insurance, users of a public utility, and network providers.

7. A system as in claim 1 wherein the rewards include any of a monetary reward if the given entity exercises, a discount if the given entity drives safely, a discount if the given entity uses less energy, and increased bandwidth in a computer network if the given entity handles certain network traffic.

8. A system as in claim 7 wherein the plurality of entities are buyers of car insurance under eighteen years of age.

9. A method for achieving a community goal, the method comprising:
establishing an egonetwork for an individual in a community;
assigning incentives across the individual's egonetwork;
measuring the individual's contributions toward the community goal;
calculating values for the incentives based on contributions by the individual toward the community goal; and
providing the incentives to members of the individual's egonetwork.

10. A method as in claim 9 wherein measuring the individual's contributions includes measuring the individual's contributions using a monitoring device.

11. A method as in claim 10 wherein measuring the individual's contributions using a monitoring device includes obtaining readings from a motion sensor of a personal communications device.

12. A method as in claim 10 wherein measuring the individual's contributions using a monitoring device includes using a software program of a computing device used by the individual to track contributions of the individual when using the computing device.

13. A method as in claim 10 wherein measuring the individual's contributions using a monitoring device includes obtaining measurements from an energy meter at a residence of the individual.

14. A method as in claim 9 wherein calculating values for the incentives includes assigning a higher value for the incentives if the contributions by the individual are in line with the community goal.

15. A method for achieving a community goal, the method comprising:
establishing positive feedback incentive relationships among individuals with preexisting relationships within a community;
notifying the individuals of incentives for working toward the community goal; and
rewarding individuals with the incentives based on positive feedback relationships with a given individual for behaviors of the given individual toward the community goal.

16. A method as in claim 15 further comprising tracking the behaviors of the given individual using a monitoring device associated with the given individual.

17. A method as in claim 16 wherein tracking the behaviors of the given individual includes obtaining motion sensor readings measuring by the monitoring device.

18. A method as in claim 16 wherein tracking the behaviors of the given individual includes obtaining results from a software program of a computing device used by the given individual, the software program configured to track the behaviors of the given individual when using the computing device.

19. A method as in claim 16 wherein tracking the behaviors of the given individual includes obtaining measurements from an energy meter at a residence of the given individual.

20. A method as in claim 15 wherein rewarding individuals with the incentives includes rewarding individuals with higher incentives if the behaviors of the given individual are in line with the community goal.

21. A method for incentivizing activities, the method comprising:
determining for a given individual a number of other individuals with whom to take part in an incentive mechanism;
notifying individuals of incentive mechanism goals and rewards;
monitoring activities of the given individual;
determining rewards for the other individuals based on the activities of the given individual; and
providing the rewards to the other individuals.

22. A method as in claim 21 wherein monitoring activities of the given individual includes monitoring activities using a monitoring device associated with the given individual.

23. A method as in claim 22 wherein monitoring activities of the given individual includes obtaining readings from a motion sensor of a personal communications device.

24. A method as in claim 22 wherein monitoring activities of the given individual includes using a software program of a computing device used by the given individual to track activities of the given individual when using the computing device.

25. A method as in claim 22 wherein monitoring activities of the given individual includes obtaining measurements from an energy meter at a residence of the given individual.

26. A method as in claim 21 wherein determining a reward for the other individuals includes determining a higher reward for the other individuals if the monitored activities of the given individual are in line with the incentive mechanism goals.

27. A system for discouraging activities, the system comprising:
a plurality of entities having preexisting relationships with a given entity;
a monitoring device associated with the given entity and configured to track activities of the given entity;
a feedback mechanism to allow the plurality of entities to provide feedback to the given entity regarding the activities of the given entity; and
a penalty mechanism configured to determine penalties for the plurality of entities based on the tracked activities of the given entity and configured to confer the penalties on the plurality of entities.

28. A method for incentivizing cooperation among a plurality of networks in communication with a given network, the plurality of networks and given network obligated to forward network traffic to adjacent networks, the method comprising:
establishing a universal quality of service charge for each unit of network traffic handled by the networks;
determining whether the given network attempts to relieve network traffic congestion to improve overall quality of service among the networks; and
allocating a portion of the received charges to networks that attempt to relieve network traffic congestion among the networks.

29. A method as in claim 28 wherein determining whether the given network attempts to relieve network traffic congestion includes determining whether the given network buffers network traffic in an attempt to relieve network traffic congestion.

30. A method as in claim 28 wherein determining whether the given network attempts to relieve network traffic congestion includes determining whether the given network selectively forwards network traffic to less-congested networks.

31. A method as in claim 28 further comprising allowing the plurality of networks to provide feedback to the given network regarding the given network's handling of network traffic.
